(19) United States
(12) Patent Application Publication
(10) Pub. No.: US 2025/0183578 A1
(43) Pub. Date: Jun. 5, 2025

(54) CONNECTOR

(71) Applicant: SUMITOMO WIRING SYSTEMS, LTD., Mie (JP)

(72) Inventors: Akihisa OGAWA, Mie (JP); Yuki HORIGUCHI, Mie (JP)

(21) Appl. No.: 18/840,503

(22) PCT Filed: Feb. 14, 2023
(86) PCT No.: PCT/JP2023/004916

§ 371 Date: Aug. 22, 2024

(30) Foreign Application Priority Data
Feb. 24, 2022 (JP) 2022-026714

(51) Int. Cl. H01R 13/46; H01R 13/629

(52) U.S. Cl. CPC H01R 13/465; H01R 13/62944

(57) ABSTRACT

A connector 1 includes a housing 10, a lever 40 assemblable with the housing 10 in a plurality of assembly modes, a base identifier 37A, 37B disposed on the housing 10 and a plurality of assembly identifiers 52A, 52B, 62A and 62B disposed on the lever 40 and respectively corresponding to the plurality of assembly modes of the lever 40. With the lever 40 assembled with the housing 10, the base identifier 37A, 37B and the assembly identifier 52A, 52B, 62A, 62B corresponding to the assembly mode of the lever are adjacent to each other to configure one of a plurality of identifiers M1, M2 corresponding to the assembly mode.

### TECHNICAL FIELD

A technique disclosed by this specification relates to a connector.

### BACKGROUND

For example, a connector is known in which a lever can be mounted on a housing in different orientations. Connectors having a lever mounted in different orientations may be treated as products different from each other and different product numbers may be given (see Patent Document 1).

In the case of manufacturing a plurality of types of connectors having a common basic structure, but having mutually different product numbers, the plurality of types of connectors can be differently manufactured by combining a common mold body and a plurality of inserts corresponding to the different product numbers (see Patent Document 2).

### PRIOR ART DOCUMENT

### Patent Document

Patent Document 1: JP 2006-302761 A
Patent Document 1: JP H11-354243 A

### SUMMARY OF THE INVENTION

### Problems to be Solved

However, in the above configuration, the configuration of a mold for connector manufacturing is complicated. Further, since it is necessary to confirm and assemble suitable inserts according to the type of the connector desired to be manufactured, time and labor increase in a manufacturing process.

### Means to Solve the Problem

A connector disclosed by this specification is provided with a base member, an assembly member assemblable with the base member in a plurality of different assembly modes, a base identifier disposed on the base member, and a plurality of assembly identifiers disposed on the assembly member, the plurality of assembly identifiers respectively corresponding to the plurality of assembly modes of the assembly member, the base identifier and the assembly identifier corresponding to the assembly mode of the assembly member being adjacent to each other to configure an identifier corresponding to the assembly mode with the assembly member assembled with the base member.

### Effect of the Invention

According to a connector disclosed by this specification, a manufacturing process can be simplified.

### BRIEF DESCRIPTION OF THE DRAWINGS

FIG. 1 is a perspective view of a connector of an embodiment.

FIG. 2 is a plan view of the connector of the embodiment.

FIG. 3 is a section along A-A of FIG. 2.

FIG. 4 is a plan view of an outer housing of the embodiment.

FIG. 5 is a perspective view of a lever of the embodiment.

FIG. 6 is a perspective view of a mating connector of the embodiment.

FIG. 7 is a side view showing the connector in a state where the lever is assembled in a first assembly mode and located at an initial position in the embodiment.

FIG. 8 is a section along B-B of FIG. 2.

FIG. 9 is a side view showing the connector in a state where the lever is assembled in the first assembly mode and located at a connection completion position in the embodiment.

FIG. 10 is a side view showing the connector in a state where the lever is assembled in a second assembly mode and located at the initial position in the embodiment.

FIG. 11 is a side view showing the connector in a state where the lever is assembled in the second assembly mode and located at the connection completion position in the embodiment.

### DETAILED DESCRIPTION TO EXECUTE THE INVENTION

### Summary of Embodiments

(1) The connector disclosed by this specification is provided with a base member, an assembly member assemblable with the base member in a plurality of different assembly modes, a base identifier disposed on the base member, and a plurality of assembly identifiers disposed on the assembly member, the plurality of assembly identifiers respectively corresponding to the plurality of assembly modes of the assembly member, the base identifier and the assembly identifier corresponding to the assembly mode of the assembly member being adjacent to each other to configure an identifier corresponding to the assembly mode with the assembly member assembled with the base member.

According to the above configuration, it is not necessary to prepare different molds and the like according to the plurality of assembly modes of the assembly member. Further, at the time of a connector assembly operation, a worker can easily confirm whether or not the assembly member is assembled in the intended assembly mode by reading the identifier. By these, a manufacturing process can be simplified.

(2) In the connector of (1) described above, the base member may be a housing to be connected to a mating connector, and the assembly member may be a lever to be assembled with the housing rotatably between an initial position and a connection completion position.

The above configuration can be suitably applied when the assembly member is a lever to be assembled rotatably with respect to the housing.

(3) In the connector of (2) described above, the plurality of assembly modes may include a first assembly mode and a second assembly mode different from the first assembly mode, an outer surface of the housing may include a base identification surface disposed with the base identifier, the lever may have a first assembly identification surface facing the same side as the base identification surface when the lever is assembled with the housing in the first assembly mode and a second assembly identification surface facing the same side as the base identification surface when the lever is assembled with the housing in the second assembly mode, and the plurality of assembly identifiers may include a first assembly identifier disposed on the first assembly identification surface and corresponding to the first assembly mode and a second assembly identifier disposed on the second assembly identification surface and corresponding to the second assembly mode.

According to this configuration, the worker can easily confirm whether or not the lever is assembled in the intended assembly mode by visually confirming the connector from the side of the base identification surface.

(4) In the connector of (3) described above, the lever may include a first rotation indicator indicating a rotation direction when the lever is assembled in the first assembly mode and a second rotation indicator indicating a rotation direction when the lever is assembled in the second assembly mode.

According to this configuration, the worker can easily know a direction, in which the lever should be rotated, and improve work efficiency at the time of connection to the mating connector.

(5) In the connector of (4) described above, the first rotation indicator may be disposed on the first assembly identification surface and the second rotation indicator may be disposed on the second assembly identification surface.

According to this configuration, the worker can easily confirm whether or not the lever is assembled in the intended assembly mode and a direction, in which the lever should be rotated, and improve work efficiency.

### DETAILS OF EMBODIMENT

A specific example of the technique disclosed by this specification is described below with reference to the drawings. Note that the present invention is not limited to these illustrations, but is represented by claims and intended to include all changes in the scope of claims and in the meaning and scope of equivalents.

### Embodiment

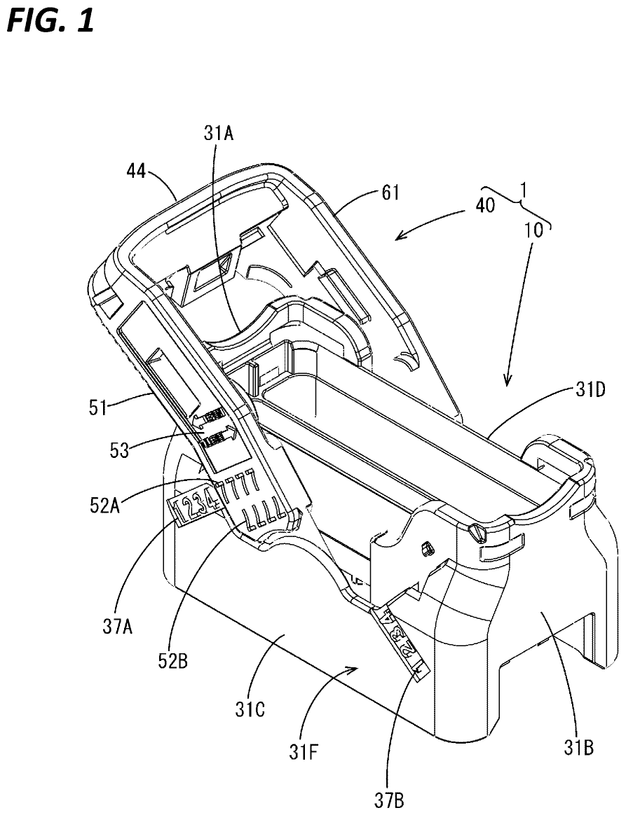

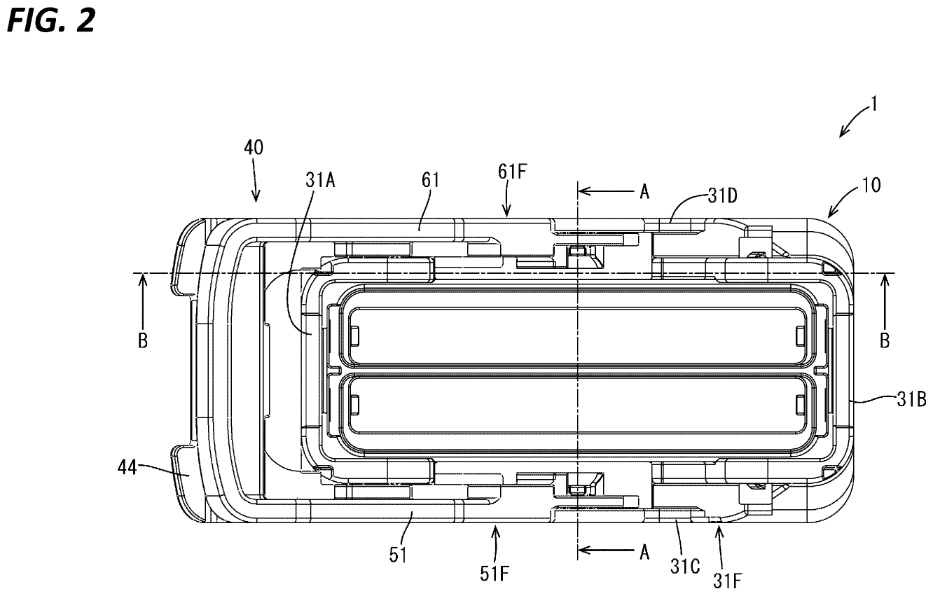

An embodiment is described with reference to FIGS. 1 to 11. As shown in FIGS. 1 and 2, a connector 1 of this embodiment is a lever-type connector provided with a housing 10 (an example of a base member) for holding terminal fittings connected to ends of wires and a lever 40 (an example of an assembly member) to be assembled with the housing 10 and configured to assist a connecting operation of the connector 10 and a mating connector 70.

### [Housing 10]

The housing 10 is made of synthetic resin and provided with an inner housing 20 and an outer housing 30 for holding the inner housing 20.

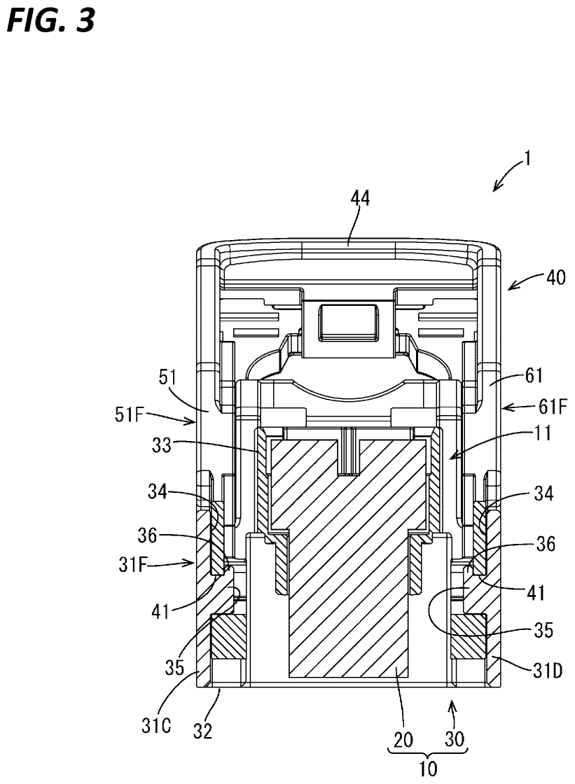

The inner housing 20 is block-like and can accommodate the terminal fittings connected to the ends of the wires inside. Note that the inner housing 20 is schematically shown in FIG. 3, but not shown in the other drawings.

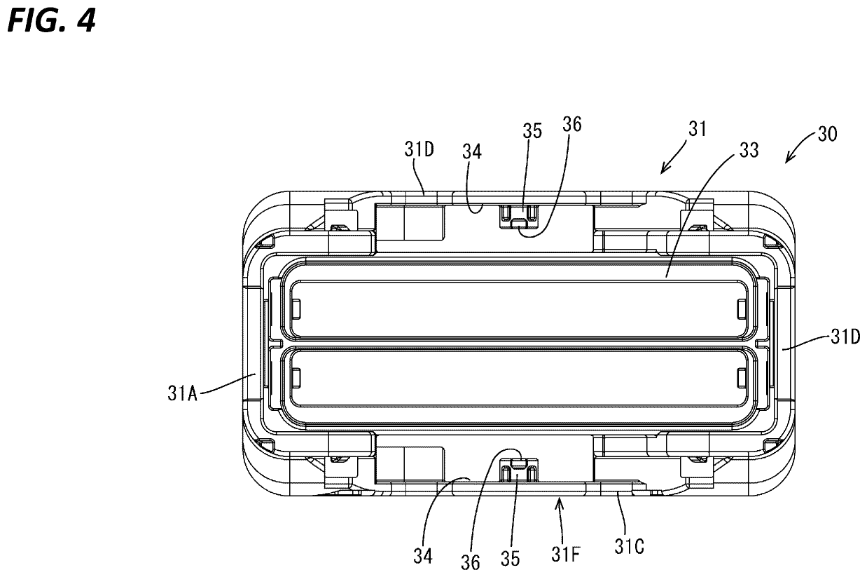

As shown in FIGS. 3 and 4, the outer housing 30 includes a fitting tube portion 31 having openings on both ends and capable of receiving the mating connector 70 inside, an inner holding portion 33 to be disposed inside the fitting tube portion 31 and two rotary shafts 35.

The fitting tube portion 31 has two end walls (first end wall 31A and second end wall 31B) disposed to face each other and two lever holding walls (first lever holding wall 31C and second lever holding wall 31D) connecting end parts of the two end walls 31A, 31B, and is in the form of a rectangular tube as a whole. One opening of the fitting tube portion 31 serves as a fitting opening 32, into which the mating connector 70 is insertable.

The inner holding portion 33 has a tubular shape as a whole and can accommodate the inner housing 20 inside. The inner housing 20 and the inner holding portion 33 constitute a terminal holding portion 11. Both end parts of the inner holding portion 33 are respectively connected to the two end walls 31A, 31B. The two lever holding walls 31C, 31D are arranged while being spaced apart from the terminal holding portion 11. Spaces defined by the two lever holding walls 31C, 31D and the terminal holding portion 11 serve as lever accommodating portions 34 open on a side opposite to the fitting opening 32.

The two rotary shafts 35 are cylindrical shafts for rotatably supporting the lever 40 and respectively project toward the terminal holding portion 11 from the two lever holding walls 31C, 31D. A retaining projection 36 for retaining the lever 40 projects from each rotary shaft 35. The retaining projection 36 is arranged adjacent to the projecting end of the rotary shaft 35.

### [Lever 40]

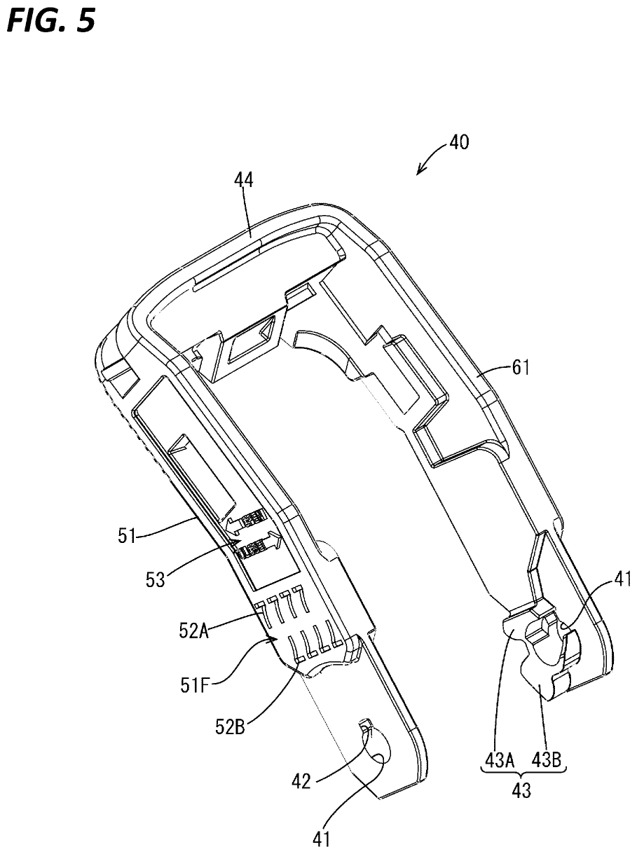

The lever 40 is a member for assisting the connection and separation of the housing 10 and the mating connector 70. The lever 40 is made of synthetic resin and is, as shown in FIG. 5, provided with two leg portions (first leg portion 51 and second leg portion 61) and a rotating portion 44 coupling end parts of the two leg portions 51, 61 and is U-shaped as a whole.

Each of the first and second leg portions 51, 61 is in the form of an elongated plate as a whole and provided with a shaft hole 41 and a gear portion 43 disposed around the shaft hole 41. The shaft hole 41 is a circular hole capable of receiving the rotary shaft 35 inside. A passage recess 42 communicating with the shaft hole 41 to allow the passage of the retaining projection 36 is disposed in a peripheral edge part of the shaft hole 41. The gear portion 43 includes a first gear tooth 43A and a second gear tooth 43B radially extending from the shaft hole 41 as a center. The first and second gear teeth 43A, 43B are arranged at an interval.

The rotating portion 44 connects base end parts of the two leg portions 51, 61 on a side opposite to tip parts where the shaft hole 41 are disposed.

The tip parts of the two leg portions 51, 61 are respectively accommodated in the two lever accommodating portions 34 as shown in FIG. 3. The first leg portion 51 is disposed along the first lever holding wall 31C, and the second leg portion 61 is disposed along the second lever holding wall 31D. The lever 40 is rotatably assembled with the housing 10 by inserting the respective rotary shaft 35 into the respective shaft holes 41. The rotary shafts 35 are prevented from coming out from the shaft holes 41 by locking the retaining projections 36 to the peripheral edge parts of the shaft holes 41 in the leg portions 51, 61.

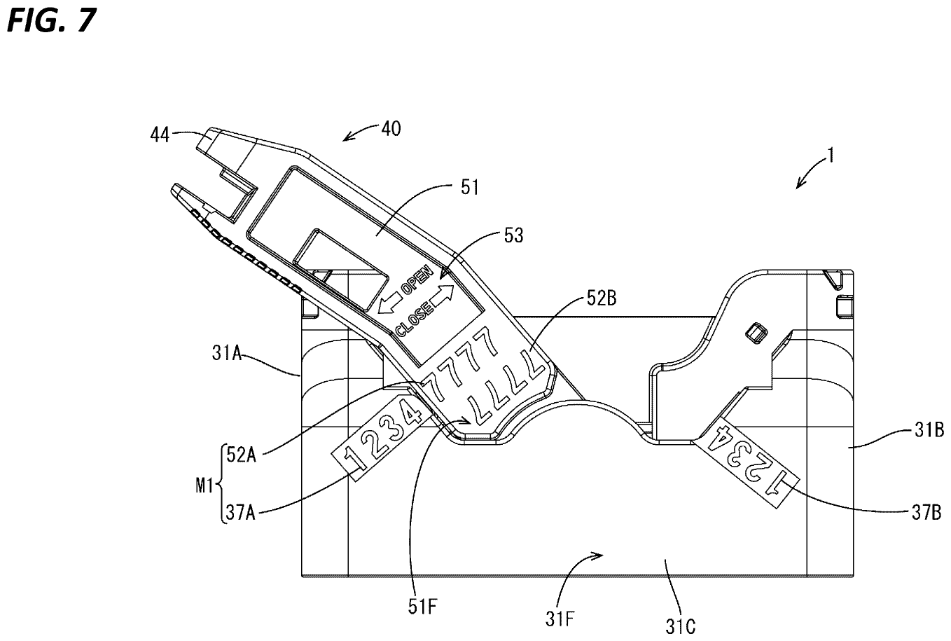

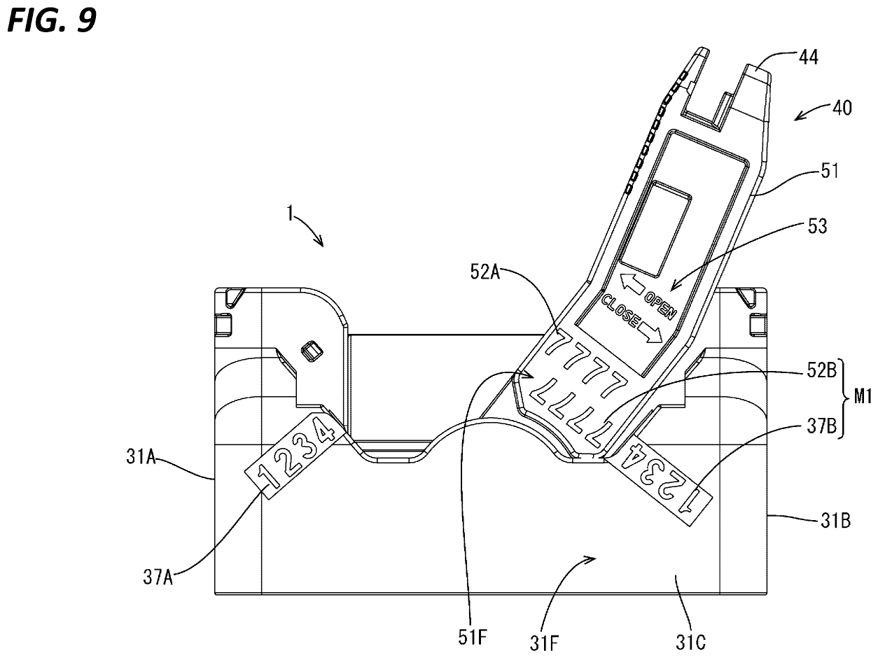

The lever 40 can be assembled with the housing 10 in two assembly modes. In the first assembly mode, the first leg portion 51 is disposed along the first lever holding wall 31C and the second leg portion 61 is disposed along the second lever holding wall 31D. When being assembled in the first assembly mode, the lever 40 is rotatable between an initial position (position shown in FIGS. 1 and 7) where the rotating portion 44 is disposed close to the first end wall 31A and a connection completion position (position show in FIG. 9) where the rotating portion 44 is disposed close to the second end wall 31B.

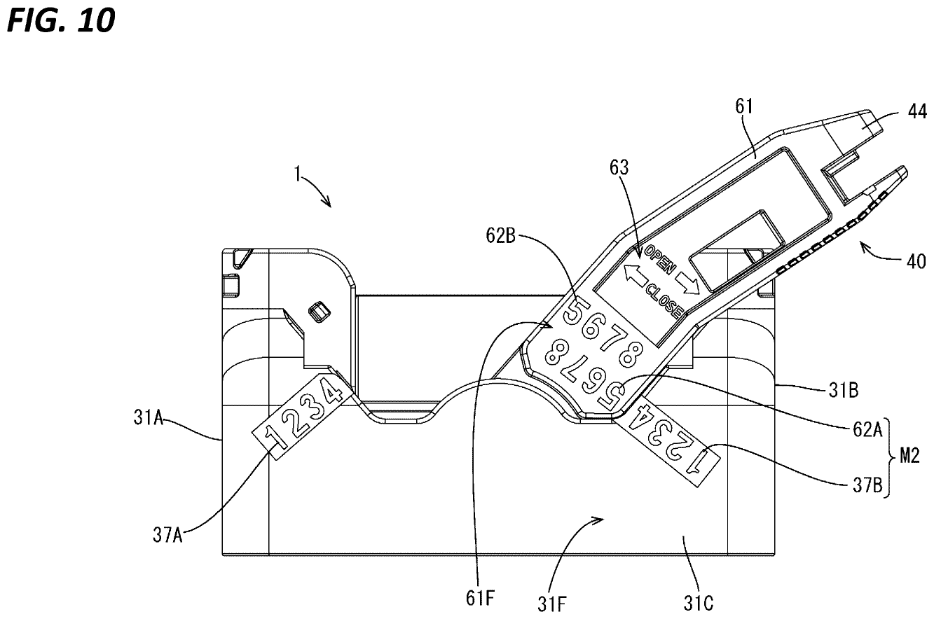

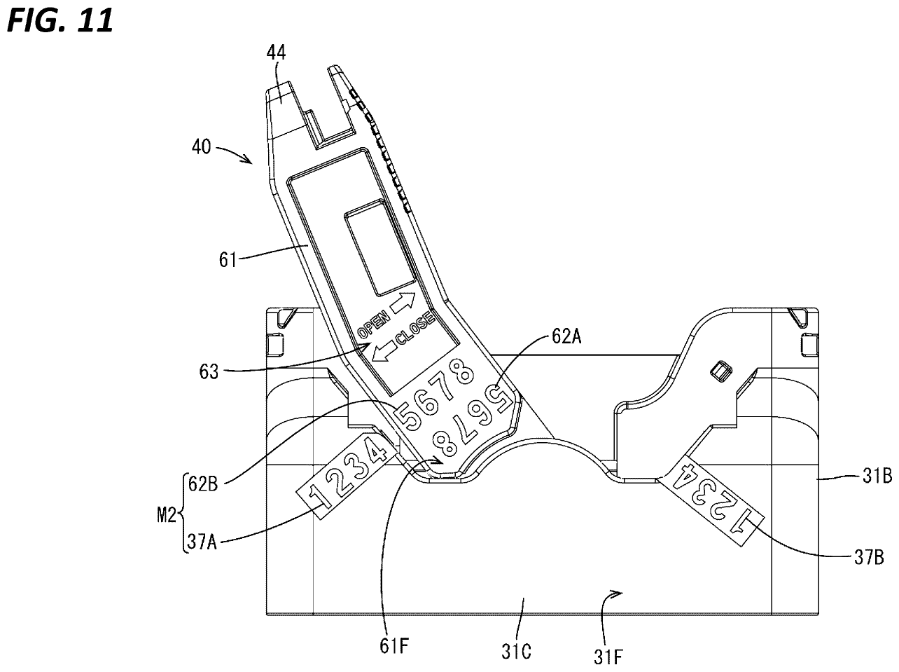

In the second assembly mode, the first leg portion 51 is disposed along the second lever holding wall 31D and the second leg portion 61 is disposed along the first lever holding wall 31C. When being assembled in the second assembly mode, the lever 40 is rotatable between an initial position (position shown in FIG. 10) where the rotating portion 44 is disposed close to the second end wall 31B and a connection completion position (position show in FIG. 11) where the rotating portion 44 is disposed close to the first end wall 31A. The initial position and the connection completion position when the lever 40 is assembled in the first assembly mode are switched from those when the lever 40 is assembled in the first assembly mode, and rotation directions from the initial position to the connection completion position and from the connection completion position to the initial position of the lever 40 are opposite to those when the lever 40 is assembled with the housing 10 in the first assembly mode.

### [Identifiers M1, M2]

As shown in FIGS. 7, 9, 10 and 11, two base identifiers 37A, 37B are disposed on the housing 10, two first assembly identifiers 52A, 52B (examples of assembly identifiers) corresponding to the first assembly mode and two assembly identifiers 62A, 62B (examples of the assembly identifiers) corresponding to the second assembly mode are disposed on the lever 50. With the lever 50 assembled with the housing 10 in the first assembly mode, either one of the two base identifiers 37A, 37B and either one of the two first assembly identifiers 52A, 52B are adjacent to each other to configure a first identifier M1 (an example of an identifier). Further, with the lever 50 assembled with the housing 10 in the second assembly mode, either one of the two base identifiers 37A, 37B and either one of the two second assembly identifiers 62A, 62B are adjacent to each other to configure a second identifier M2 (an example of the identifier). This is further described below.

As shown in FIGS. 1 and 7, the outer surface of the first lever holding wall 31C serves as a base identification surface 31F, and the two base identifiers (first base identifier 37A and second base identifier 37B) are engraved at mutually different positions in this base identification surface 31F. In this embodiment, the two base identifiers 37A, 37B are composed of common four characters and represent a type of the housing 10. The first base identifier 37A is disposed close to the first end wall 31A, and the second base identifier 37B is disposed close to the second end wall 31B.

In the first leg portion 51 of the lever 40, an outer surface facing opposite to the second leg portion 61 serves as a first assembly identification surface 51F as shown in FIGS. 1 and 7, and the two first assembly identifiers 52A, 52B are engraved in this first assembly identification surface 51F.

The two first assembly identifiers 52A, 52B are composed of common four characters and represent that the lever 40 is assembled in the first assembly mode. If the lever 40 is assembled in the first assembly mode, the first leg portion 51 is disposed along the first lever holding wall 31C and the first assembly identification surface 51F is disposed to face the same side as the base identification surface 31F. When the lever 40 is at the initial position, one first assembly identifier 52A is disposed at a position adjacent to the first base identifier 37A and the first base identifier 37A and the one first assembly identifier 52A are aligned in a row to configure the first identifier M1 composed of eight characters as shown in FIG. 7. Further, when the lever 40 is at the connection completion position, the other first assembly identifier 52B is disposed at a position adjacent to the second base identifier 37B and the second base identifier 37B and the other first assembly identifier 52B are aligned in a row to configure the first identifier M1 composed of eight characters as shown in FIG. 9. The first identifier M1 represents a model number of the connector 1 when the lever 40 is assembled in the first assembly mode.

In the second leg portion 61 of the lever 40, an outer surface facing opposite to the first leg portion 51 serves as a second assembly identification surface 61F as shown in FIG. 10, and the two second assembly identifiers 62A, 62B are engraved in this second assembly identification surface 61F.

The two second assembly identifiers 62A, 62B are composed of common four characters different from the first assembly identifiers 52A, 52B. The two second assembly identifiers 62A, 62B represent that the lever 40 is assembled in the second assembly mode. If the lever 40 is assembled in the second assembly mode, the second leg portion 61 is disposed along the first lever holding wall 31C and the second assembly identification surface 61F is disposed to face the same side as the base identification surface 31F. When the lever 40 is at the initial position, one second assembly identifier 62A is disposed at a position adjacent to the second base identifier 37B and the second base identifier 37B and the one second assembly identifier 62A are aligned in a row to configure the second identifier M2 composed of eight characters as shown in FIG. 10. Further, when the lever 40 is at the connection completion position, the other second assembly identifier 62B is disposed at a position adjacent to the first base identifier 37A and the first base identifier 37A and the other second assembly identifier 62B are aligned in a row to configure the second identifier M2 composed of eight characters as shown in FIG. 11. The second identifier M2 represents a model number of the connector 1 when the lever 40 is assembled in the second assembly mode.

### [Rotation Indicators 53, 63]

A first rotation indicator 53 is engraved in the first assembly identification surface 51F of the first leg portion 51 as shown in FIGS. 7 and 9. The first rotation indicator 53 is an indictor indicating the rotation directions from the initial position to the connection completion position and from the connection completion position to the initial position of the lever 40 when the lever 40 is assembled in the first assembly mode. A second rotation indicator 63 is engraved in the second assembly identification surface 61F of the second leg portion 61 as shown in FIGS. 10 and 11. The second rotation indicator 63 is an indictor indicating the rotation directions from the initial position to the connection completion position and from the connection completion position to the initial position of the lever 40 when the lever 40 is assembled in the second assembly mode.

### [Mating Connector 70]

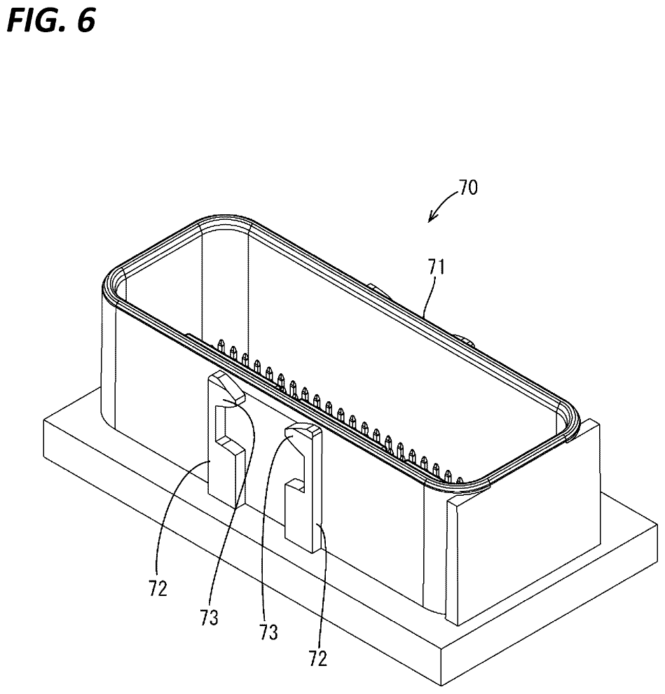

As shown in FIG. 6, the mating connector 70 is provided with a tubular receptacle 71 and two gear receiving portions 72 disposed on the outer surface of the receptacle 71 and corresponding to the two gear portions 43 respectively provided on the two leg portions 51, 61 of the lever 40. Each gear receiving portion 72 includes gear projections 73 projecting from the outer surface of the receptacle 71 and to be meshed with the gear teeth 43A, 43B of the gear portion 43.

### [Assembly of Connector 1]

An example of an assembly procedure of the connector 1 configured as described above is described below. First, the terminal fittings connected to the ends of the wires are mounted into the inner housing 20. Subsequently, the inner housing 20 is assembled with the inner holding portion 33.

Subsequently, the lever 40 is assembled with the housing 10. With the lever 40 set in an assembly posture upright to the housing 10, the two leg portions 51, 61 are deflected inward and the tip parts of the respective leg portions 51, 61 are inserted into the respective lever accommodating portions 34. Since the positions of the passage recesses 42 disposed in the peripheral edge parts of the shaft holes 41 are aligned with the retaining projections 36 when the lever 40 is in the assembly posture, the retaining projections 36 are allowed to pass through the passage recesses 42 and the entrance of the rotary shafts 35 into the shaft holes 41 is allowed. If the rotary shafts 35 are fit into the shaft holes 41, the respective leg portions 51, 61 resiliently return and are disposed along the respective lever holding walls 31C, 31D.

Thereafter, the lever 40 is rotated from the assembly posture to the initial position. If the lever 40 is rotated to a position shifted from the assembly posture, the positions of the passage recesses 42 are not aligned with the retaining projections 36. Thus, the retaining projections 36 are engaged with the peripheral edge parts of the shaft holes 41 to restrict the separation of the lever 40 from the housing 10. In this way, the assembly of the lever 40 with the housing 10 is completed.

As described above, if the lever 40 is assembled in the first assembly mode and located at the initial position, the first base identifier 37A and the first assembly identifier 52A are aligned in a row to configure the first identifier M1 composed of eight characters as shown in FIG. 7. On the other hand, if the lever 40 is assembled in the second assembly mode and located at the initial position, the second base identifier 37B and the second assembly identifier 62A are aligned in a row to configure the second identifier M2 composed of eight characters as shown in FIG. 10. A worker can easily confirm whether or not the lever 40 is assembled in the intended assembly mode by reading which of the first and second identifiers M1, M2 is configured.

### [Connection of Connector 1 and Mating Connector 70]

Next, an example of a procedure of connecting the connector 1 configured as described above to the mating connector 70 is described below.

First, a case where the lever 40 is assembled in the first assembly mode is described. With the lever 40 disposed at the initial position, the first base identifier 37A disposed on the first lever holding wall 31C and the one first assembly identifier 52A disposed on the first leg portion 51 are aligned in a row to configure the first identifier M1 composed of eight characters as shown in FIG. 7. Further, the first rotation indicator 53 is also disposed on the first assembly identification surface 51F disposed with the first assembly identifiers 52A, 52B. As just described, in the connector 1, the first rotation indicator 53 is disposed on the same side as the one where the first identifier M1 appears, and the worker can confirm whether or not the lever 40 is assembled in the intended assembly mode and easily know a direction, in which the lever 40 should be rotated, by confirming these first identifier M1 and first rotation indicator 53.

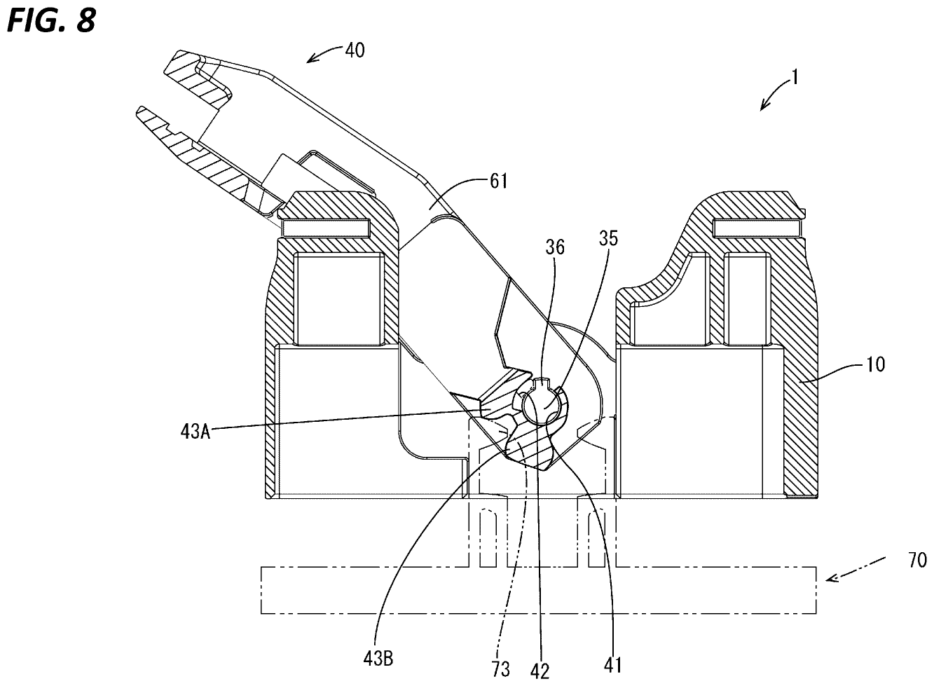

With the lever 40 held at the initial position, the housing 10 is lightly connected to the mating connector 70 and a tip part of the receptacle 71 enters the fitting tube portion 31. With the lever 40 disposed at the initial position, the gear projection 73 can enter between the two gear teeth 43A, 43B as shown in FIG. 8.

Subsequently, the lever 40 is rotated from the initial position toward the connection completion position. The worker confirms the first rotation indicator 53 and rotates the lever 40 from the initial position to the connection completion position (i.e. in a rightward direction of FIG. 7) according to an arrow “CLOSE”. According to the rotation of the lever 40, the gear portions 43 rotate and the second gear teeth 43B move toward the back of the housing 10 and the gear receiving portions 72 engaged with the second gear teeth 43B are pulled to the back of the housing 10. Along with this, the housing 10 is relatively pulled toward the mating connector 70 and connection proceeds.

If the lever 40 reaches the connection completion position, the housing 10 reaches a proper connection position with respect to the mating connector 70. In this state, as shown in FIG. 9, the second base identifier 37B disposed on the first lever holding wall 31C and the other second assembly identifier 52B disposed on the first leg portion 51 are aligned in a row to configure the first identifier M1 composed of eight characters. In this way, the first identifier M1 is configured also when the lever 40 is at the connection completion position. Thus, whether or not the lever 40 is assembled in the intended assembly mode can be easily confirmed also after the connector 1 is connected to the mating connector 70.

Further, in separating the connector 1 from the mating connector 70 for maintenance or the like, the worker can confirm the first rotation indicator 53 and easily know a direction, in which the lever 40 should be rotated, by visually confirming the connector 1 from the side of the base identification surface 31F, on which the first identifier M1 appears. The worker confirms the first rotation indicator 53 and rotates the lever 40 from the connection completion position toward the initial position (i.e. in a leftward direction of FIG. 9) according to an arrow “OPEN”. In this way, the connector 1 is separated from the mating connector 70.

Next, a case where the lever 40 is assembled in the second assembly mode is described. With the lever 40 disposed at the initial position, the second base identifier 37B disposed on the first lever holding wall 31C and the one second assembly identifier 62A disposed on the second leg portion 61 are aligned in a row to configure the second identifier M2 composed of eight characters as shown in FIG. 10. Further, the second rotation indicator 63 is also disposed on the second assembly identification surface 61F disposed with the second assembly identifiers 62A, 62B. As just described, in the connector 1, the second rotation indicator 63 is disposed on the same side as the one where the second identifier M2 appears, and the worker can confirm whether or not the lever 40 is assembled in the intended assembly mode and easily know a direction, in which the lever 40 should be rotated, by confirming these second identifier M2 and second rotation indicator 63.

As in the case where the lever 40 is assembled in the first assembly mode, the lever 40 is rotated from the initial position to the connection completion position with the housing 10 lightly connected to the mating connector 70. The worker rotates the lever 40 from the initial position toward the connection completion position (i.e. in a leftward direction of FIG. 10) according to the arrow “CLOSE”.

When the lever 40 reaches the connection completion position, the first base identifier 37A disposed on the first lever holding wall 31C and the other second assembly identifier 62B disposed on the second leg portion 61 are aligned in a row to configure the second identifier M2 composed of eight characters as shown in FIG. 11. Since the second identifier M2 is configured also when the lever 40 is at the connection completion position in this way, whether or not the lever 40 is assembled in the intended assembly mode can be easily confirmed also after the connector 1 is connected to the mating connector 70.

Further, in separating the connector 1 from the mating connector 70 for maintenance or the like, the worker can confirm the second rotation indicator 63 and easily know a direction, in which the lever 40 should be rotated, by visually confirming the connector 1 from the side of the base identification surface 31F, on which the second identifier M2 appears. The worker confirms the second rotation indicator 63 and rotates the lever 40 from the connection completion position toward the initial position (i.e. in a rightward direction of FIG. 11) according to the arrow “OPEN”. In this way, the connector 1 is separated from the mating connector 70.

### Functions and Effects

As described above, according to this embodiment, the connector 1 is provided with the housing 10, the lever 40 assemblable with the housing 10 in a plurality of assembly modes, the base identifiers 37A, 37B disposed on the housing 10, and the plurality of assembly identifiers 52A, 52B, 62A and 62B disposed on the lever 40 and respectively corresponding to the plurality of assembly modes of the lever 40, and the base identifier 37A, 37B and the assembly identifier 52A, 52B, 62A, 62B corresponding to the assembly mode of the lever 40 are adjacent to each other to configure one of the plurality of identifiers M1, M2 corresponding to the assembly mode with the lever 40 assembled with the housing 10.

According to the above configuration, it is not necessary to prepare different molds and the like according to the plurality of assembly modes of the lever 40. Further, during an assembly operation of the connector 1, whether or not the lever 40 is assembled in the intended assembly mode can be easily confirmed by the worker reading the identifier M1, M2. A manufacturing process can be simplified by these.

Further, the assembly modes include the first assembly mode and the second assembly mode different from the first assembly mode, the outer surface of the housing 10 includes the base identification surface 31F disposed with the base identifiers 37A, 37B, the lever 40 has the first assembly identification surface 51F facing the same side as the base identification surface 31F when the lever 40 is assembled with the housing 10 in the first assembly mode and the second assembly identification surface 61F facing the same side as the base identification surface 31F when the lever 40 is assembled with the housing 10 in the second assembly mode different from the first assembly mode, and the assembly identifiers 52A, 52B, 62A and 62B include the first assembly identifiers 52A, 52B disposed on the first assembly identification surface 51F and corresponding to the first assembly mode and the second assembly identifiers 62A, 62B disposed on the second assembly identification surface 61F and corresponding to the second assembly mode.

According to this configuration, the worker can easily confirm whether or not the lever 40 is assembled in the intended assembly mode by visually confirming the connector 1 from the side of the base identification surface 31F.

Further, the lever 40 is provided with the first rotation indicator 53 indicating the rotation directions when the lever 40 is assembled in the first assembly mode and the second rotation indicator 63 indicating the rotation directions when the lever 40 is assembled in the second assembly mode.

According to this configuration, at the time of connection to the mating connector 70, the worker can easily know the direction, in which the lever 40 should be rotated, and improve work efficiency.

Further, the first rotation indicator 53 is disposed on the first assembly identification surface 51F and the second rotation indicator 63 is disposed on the second assembly identification surface 61F.

According to this configuration, the worker can easily confirm whether or not the lever 40 is assembled in the intended assembly mode and the direction, in which the lever 40 should be rotated, and improve work efficiency.

### Other Embodiments

(1) Although the assembly member is the lever in the above embodiment, the type of the assembly member is not limited to that of the above embodiment and may be, for example, a cover for covering the wires by being assembled with the housing.

(2) Although the lever is rotatably assembled with the housing in the above embodiment, the assembly mode of the lever is not limited to that of the above embodiment and, for example, the lever may be slidably assembled with the housing.

(3) Although the lever 40 can be assembled with the housing 10 in two assembly modes in the above embodiment, an assembly member may be assemblable with a base member in three or more assembly modes.

(4) Although the identifier is composed of eight characters in the above embodiment, the number of characters of the identifier is not particularly limited. Further, although the identifier is composed of characters representing the model number in the above embodiment, the type of the identifier is not limited to that of the above embodiment and may be, for example, characters or symbols other than numbers or a combination of these.

(5) Although the base identifiers and the assembly identifiers are engraved in the above embodiment, an identifier forming method is not limited to that of the above embodiment and, for example, identifiers may be printed on the surfaces of the base member and the assembly member or seals printed with identifiers may be attached to the surfaces of the base member and the assembly member. The same also applies to the first and second rotation indicators.

### LIST OF REFERENCE NUMERALS

1: connector
10: housing (base member)
11: terminal holding portion
20: inner housing
30: outer housing
31: fitting tube portion
31A: first end wall
31B: second end wall
31C: first lever holding wall
31D: second lever holding wall
31F: base identification surface
32: fitting opening
33: inner holding portion
34: lever accommodating portion
35: rotary shaft
36: retaining projection
37A: first base identifier (base identifier)
37B: second base identifier (base identifier)
40 lever (assembly member)
41: shaft hole
42 passage recess
43: gear portion
43A: first gear tooth
43B: second gear tooth
44 rotating portion
51: first leg portion
51F: first assembly identification surface
52A, 52B: first assembly identifier (assembly identifier)
53 first rotation indicator
61: second leg portion
61F: second assembly identification surface
62A, 62B: second assembly identifier (assembly identifier)
63: second rotation indicator
70: mating connector
71 receptacle
72: gear receiving portion
73: gear projection
M1: first identifier (identifier)
M2: second identifier (identifier)

1. A connector, comprising:
a base member;
an assembly member assemblable with the base member in a plurality of different assembly modes;
a base identifier disposed on the base member, the base identifier being composed of X characters;
a plurality of assembly identifiers disposed on the assembly member and each composed of Y characters, the plurality of assembly identifiers respectively corresponding to the plurality of assembly modes of the assembly member,
the base identifier and the assembly identifier corresponding to the assembly mode of the assembly member being aligned in a row to configure an identifier corresponding to the assembly mode and composed of (X+Y) characters with the assembly member assembled with the base member.

2. The connector according to claim 1, wherein the base member is a housing to be connected to a mating connector, and the assembly member is a lever to be assembled with the housing rotatably between an initial position and a connection completion position.

3. The connector according to claim 2, wherein:
the plurality of assembly modes include a first assembly mode and a second assembly mode different from the first assembly mode,
an outer surface of the housing includes a base identification surface disposed with the base identifier,
the lever has a first assembly identification surface facing the same side as the base identification surface when the lever is assembled with the housing in the first assembly mode and a second assembly identification surface facing the same side as the base identification surface when the lever is assembled with the housing in the second assembly mode, and
the plurality of assembly identifiers include a first assembly identifier disposed on the first assembly identification surface and corresponding to the first assembly mode and a second assembly identifier disposed on the second assembly identification surface and corresponding to the second assembly mode.

4. The connector according to claim 3, wherein the lever includes a first rotation indicator indicating a rotation direction when the lever is assembled in the first assembly mode and a second rotation indicator indicating a rotation direction when the lever is assembled in the second assembly mode.

5. The connector according to claim 4, wherein the first rotation indicator is disposed on the first assembly identification surface and the second rotation indicator is disposed on the second assembly identification surface.
